(19) United States
(12) Patent Application Publication
(10) Pub. No.: US 2010/0066882 A1
(43) Pub. Date: Mar. 18, 2010

(54) SOLID-STATE IMAGE CAPTURING ELEMENT AND ELECTRONIC INFORMATION DEVICE

(75) Inventor: Kenichi Nagai, Osaka (JP)

Correspondence Address: EDWARDS ANGELL PALMER & DODGE LLP, P.O. BOX 55874, BOSTON, MA, 02205, US

(73) Assignee: SHARP KABUSHIKI KAISHA, Osaka (JP)

(21) Appl. No.: 12/557,153

(22) Filed: Sep. 10, 2009

(30) Foreign Application Priority Data
Sep. 18, 2008 (JP) 2008-240089

(51) Int. Cl. H04N 5/335

(52) U.S. Cl. 348/308; 348/E05.091; 348/311

(57) ABSTRACT

A solid-state image capturing element according to the present invention includes a pixel array section, in which a well layer is disposed above a semiconductor substrate or a semiconductor region and a plurality of photoelectric conversion elements for performing a photoelectric conversion on and capturing an image of image light from a subject are arranged in a two dimensional array in the well layer, where a high concentration well layer is disposed between the well layer and the semiconductor substrate or the semiconductor region, the high concentration well layer being a same conductivity type as the well layer and having a higher impurity concentration than that of the well layer.

This nonprovisional application claims priority under 35 U.S.C. §119(a) to Patent Application No. 2008-240089 filed in Japan on Sep. 18, 2008, the entire contents of which are hereby incorporated by reference.

### BACKGROUND OF THE INVENTION

1. Field of the Invention

The present invention relates to a solid-state image capturing element, such as a CMOS solid-state image capturing element, constituted of a semiconductor element for performing a photoelectric conversion on and capturing an image of image light from a subject; and an electronic information device, such as a digital camera (e.g., a digital video camera or a digital still camera), an image input camera, a scanner, a facsimile machine, a television telephone device and a camera-equipped cell phone device, including the solid-state image capturing apparatus as an image input device used in an image capturing section thereof.

2. Description of the Related Art

One of the performances required of conventional solid-state image capturing elements is the increasing number of pixels arranged in a two dimensional array. In CMOS solid-state image capturing elements, each element of pixels are formed in one well, and the well is electrically set in the periphery of a pixel array section. However, as the well area of the pixel array section increases as a result of the increase of pixels, it becomes difficult to fix a reference voltage to a ground voltage up to the center portion. As a result, the following problems occur.

One of the problems is that a transistor threshold value differs at a center portion from a peripheral portion of a pixel array section functioning as an image capturing area. Furthermore, since there is a difference in a resistance value reaching the center portion and that of the peripheral portion of the pixel array section, there is a difference in the amount of saturation charges (saturation level) among pixels. This is referred to as saturation shading.

In order to solve the abovementioned problems, Reference 1 describes a method for making a well contact for each pixel without changing an area of an active region. As described in Reference 1, it becomes possible to fix a well at a constant ground potential near a photoelectric conversion region by disposing a contact for each pixel.

FIG. 5 is a plane-surface pattern diagram illustrating a pixel structure according to a conventional solid-state image capturing element disclosed in Reference 1. FIG. 6 is a cross sectional view along the line A-A′ of FIG. 5.

In FIGS. 5 and 6, a gate electrode 101 of a conventional solid-state image capturing element 100 is disposed between a photoelectric conversion region (active region) 103 and an active region 104 of a photoelectric conversion element 102 so as to configure a transfer transistor 105. The active region 104 functions as not only a drain region of the transfer transistor 105 but also a source region of a reset transistor 107 and a gate input section of an amplification transistor 106. A gate electrode 108 is disposed between the active region 104 and an active region 109 so as to configure the reset transistor 107. The active region 109 functions as not only a drain region of the reset transistor 107 but also a drain region of the amplification transistor 106.

A gate electrode 110 is disposed between the active region 109 and an active region 111 so as to configure the amplification transistor 106. The active region 111 functions as not only a source region of the amplification transistor 106 but also a drain region of a selection transistor 112. A gate electrode 113 is disposed between the active region 111 and an active region 114 so as to configure the selection transistor 112. The active region 114 is a source region of the selection transistor 112 and is electrically connected to a pixel output line 116, which is a metal wiring, at a contact section 115.

In the pixel structure as described above, a corner of a rectangular region of the active region (photoelectric conversion region) 103 of the photoelectric conversion element 102 is evenly planed off, and the planed region is used as a well contact region 117. That is, the photoelectric conversion region 103 and the well contact region 117 of the photoelectric conversion element 102 are formed in the same active region. The well contact region 117 is electrically connected at a contact section 119 with a metal wiring 118, which extends in a vertical direction (longitudinal direction in FIG. 5), for supplying a constant potential, such as a ground potential (0V), to configure a well potential fixing section.

In the example of FIG. 6 (cross section along the line A-A′ of FIG. 5), a P-well 121 is formed above an N-type substrate 120, and the photoelectric conversion element 102 of a pixel as well as the afore-mentioned transistors 106, 107 and 112 are formed in the P-well 121. As illustrated in FIG. 5, an N-region 122 is the active region 104 connected at a contact section 123 with the gate electrode 110 of the amplification transistor 106, with a metal wiring 124 interposed therebetween.

The photoelectric conversion region 103 is formed of an N-type impurity region 125, a P+ region 126 near the surface of the N-type impurity region 125, and a P well 121 in the periphery. The P+ region 126 is an active region (active region of the well contact region 117 of FIG. 5) connected from a diffusion layer through the contact section 119 to the metal wiring 118, and is capable of fixing the electric potential of the P well 121 at the ground potential (0V) through the metal wiring 118. It is possible to not influence the photoelectric conversion region 103 to be affected by the well contact region 117 by introducing a P+ impurity, which has a higher concentration than the P+ region 126 near the surface of the photoelectric conversion region 103, into the P+ region 127. An element separation region 128 is LOCOS (Local Oxidization on Silicon), STI (Shallow Trench Isolation) or the like, and it is formed between the photoelectric conversion element 102 and the transistors 106, 107 and 112 to electrically separate the elements.

As described above, in the solid-state image capturing apparatus with the structure of making a well contact for each pixel, an element separation region is not disposed between the well contact region 117 and the active region 103 of the photoelectric conversion element 102, and the well contact region 117 is formed in the active region 103, in which the photoelectric conversion element 102 is also formed. Therefore, a portion used as an element separation region in the conventional technique can be assigned as the active region 103 of the photoelectric conversion element 102, which enables to reduce a load imposed on other elements due to the disposal of the well contact region 117.

Specifically, when forming the well contact region 117 for making a well contact for each pixel, in the active region 103 of the photoelectric conversion element 102 without changing the size of the pixel, the area planed off from the active region 103 can be smaller than in the conventional technique, thereby suppressing the lowering of characteristics of the pixel, or particularly the lowering of the saturation level and the sensitivity, to the minimum. As a result, the electric potential of the P well 121 can be electrically and firmly fixed, thereby suppressing the increase of the area per unit pixel (size of the pixel) while controlling the shading of output signals due to the change of the well potential.

Further, according to Reference 2, as illustrated in FIG. 7, a conventional solid-state image capturing element 200 is configured with an active region 201, in which a photodiode PD is also formed, and in the example, two well contacts 202A and 202B are disposed in the active region 201. The photodiode PD is formed in a shape, in which a concave portion 203 can be formed in a part of the photodiode PD, and the two well contact 202A and 202B are formed in the active region 201 corresponding to the concave section 203. Three or more well contacts 202 may be used; however an appropriate number is determined considering a balance since using too many well contacts will lead to a decrease of the area for the photodiode PD and lowering the amount of saturation signals. A well wiring 204 is formed partially traversing the photodiode PD to connect to both the well contacts 202A and 202B arranged in a horizontal direction. In a pixel 205 of FIG. 7, the portion except for the active region 201 and the transistor 206 is formed as an element separation region 207. Because of this, in Reference 2, two well contacts 202A and 202B are disposed per pixel and a parallel connection is made by the two well contacts 202A and 202B. As a result, since the connection is made only by two connection points, the resistance value can be smaller, the ground potential can be further stabilized, and the saturation shading can be further controlled.

In Reference 3, comparing the center portion and the peripheral portion of a plurality of pixel sections, the pixels at the center portion have a smaller saturation amount of signal charges than the peripheral portion. That is, the pixels at the center portion lack the accumulation amount of signal charges more than the peripheral portion. This is because the peripheral portion of the pixel array section is entirely electrically fixed to the ground potential (0V) with respect to the well. In order to control the saturation shading, in the case where there is an electric charge accumulating capacity of the photodiode PD and an electric charge accumulating capacity of a potential wall portion under a transfer gate TG of a transfer transistor and a floating diffusion FD as illustrated in FIG. 8, the potential wall portion becomes lower by the transfer gate TG and the potential wall portion between the photodiode PD and the floating diffusion FD is eliminated, so that the signal charges accumulated in the electric charge accumulating capacity of the photodiode PD are transferred to the electric charge accumulating capacity of the floating diffusion FD. Subsequently, a potential wall portion is created between the photodiode PD and the floating diffusion FD and signal charges are accumulated in the photodiode PD.

When the electric potential of the P well changes, the electric charge accumulating capacity of the photodiode PD becomes shallow as indicated by the arrow, making the electric charge accumulating capacity smaller. Alternatively, the transfer gate TG is normally fixed to 0V at the off state; however, in Reference 3, the electric potential of the transfer gate TG is in a floating state. Because of this, for the amount that the electric potential of the P well changes and the electric charge accumulating capacity of the photodiode PD becomes shallow as indicated by the arrow, the electric potential of the transfer gate TG also changes as indicated by another arrow and the potential wall portion becomes higher so that there will be no change in the electric charge accumulating capacity of the photodiode PD.

In order to make the electric potential of the transfer gate TG in a floating state in this case, 0V is not applied to the transfer gate TG at the off state, and a switch is arranged in between and is turned off.

Reference 1: Japanese Laid-Open Publication No. 2005-142251

Reference 2: Japanese Laid-Open Publication No. 2006-269546

Reference 3: Japanese Laid-Open Publication No. 2005-217705

### SUMMARY OF THE INVENTION

In the method for making a well contact for each pixel as used in the conventional solid-state image capturing element of References 1 and 2, although there is no change in the active region area, the photoelectric conversion region becomes certainly smaller, which creates a problem of lowering the saturation level. Further, since the contact is formed near the vicinity of the photoelectric conversion region and there is an influence of contact etching, a crystal defect occurs resulting in causing a bright point defect (fixed pattern noise). Further, another wiring is additionally required in order to fix the well to the ground, so that the wiring aperture ratio decreases and the focusing of light is negatively affected.

According to the conventional solid-state image capturing element of Reference 3, the electric charge accumulating capacity of the photodiode PD changes due to the change of the electric potential of the P well. Following this, the electric potential of the transfer gate TG in the floating state also changes. Although there is no change in the electric charge accumulating capacity of the photodiode PD, a switch for making the transfer gate TG in a floating state and a control circuit for the switch are required, which leads to the problem of an increase in the number of members and more complicated controlling due to the addition of the floating control other than the controlling of electric charge transferring of the transfer gate TG.

The present invention is intended to solve the conventional problems described above. The objective of the present invention is to provide a solid-state image capturing element: capable of avoiding a complication due to an increased number and controlling of parts as is required conventionally, as well as capable of fixing the ground potential of the well in a more stable manner, without forming a well contact for each pixel, or without the generation of a fixed pattern noise, saturation level difference (saturation shading) or the decrease in focusing of light, as is required conventionally. Furthermore, the objective of the present invention is to provide an electronic information device, such as a camera-equipped cell phone device, including the solid-state image capturing element used as an image input device in an image capturing section.

A solid-state image capturing element according to the present invention includes a pixel array section, in which a well layer is disposed above a semiconductor substrate or a semiconductor region and a plurality of photoelectric conversion elements for performing a photoelectric conversion on and capturing an image of image light from a subject are arranged in a two dimensional array in the well layer, wherein a high concentration well layer is disposed between the well layer and the semiconductor substrate or the semiconductor region, the high concentration well layer being a same conductivity type as the well layer and having a higher impurity concentration than that of the well layer, thereby achieving the objective described above.

Preferably, in a solid-state image capturing element according to the present invention, a peak concentration of the high concentration well layer is between 1×10¹⁷ cm⁻³ and 5×10¹⁷ cm⁻³.

Still preferably, in a solid-state image capturing element according to the present invention, a sheet resistance of the high concentration well layer is between 800 Ω/sq.-2000 Ω/sq.

Still preferably, in a solid-state image capturing element according to the present invention, a depth of the high concentration well layer is between 3 μm and 4 μm from a surface.

Still preferably, in a solid-state image capturing element according to the present invention, the well layer and the high concentration well layer are fixed at a constant electric potential from an outer circumference portion side of the pixel array section.

Still preferably, in a solid-state image capturing element according to the present invention, of the well layers, the well layer on the outer circumference portion side of the pixel array section is electrically connected to a metal wiring with a plurality of contacts interposed therebetween.

Still preferably, in a solid-state image capturing element according to the present invention, each photoelectric conversion element includes: the well layer of a second conductivity type disposed above the semiconductor substrate of a first conductivity type or the semiconductor region of the first conductivity type; and an impurity region of the first conductivity type disposed in the well layer of the second conductivity type.

Still preferably, in a solid-state image capturing element according to the present invention, the impurity region of the first conductivity type is buried by a surface impurity high concentration region of the second conductivity type thereabove.

Still preferably, in a solid-state image capturing element according to the present invention, each pixel of the pixel array section is separated from other pixels by the impurity region of the same conductivity type as that of the well layer.

Still preferably, in a solid-state image capturing element according to the present invention, the solid-state image capturing element is a CMOS-type solid-state image capturing element or a CCD-type solid-state image capturing element.

Still preferably, in a solid-state image capturing element according to the present invention, each pixel in the pixel array section includes: an electric charge transfer section for transferring a signal charge photoelectrically converted in the photoelectric conversion element to a voltage detecting section; and a signal reading circuit for amplifying a signal voltage detected from the signal charges at the voltage detecting section to be output as an image capturing signal.

Still preferably, in a solid-state image capturing element according to the present invention, the signal reading circuit includes: an amplifying section for amplifying the signal voltage detected at the voltage detecting section to be output as the image capturing signal; and a reset section for resetting the signal voltage of the voltage detecting section to a predetermined voltage after outputting the image capturing signal.

Still preferably, in a solid-state image capturing element according to the present invention, the signal reading circuit further includes a selection section for selecting a pixel of any address in the pixel array section for each pixel of the pixel array section.

Still preferably, a solid-state image capturing element according to the present invention further includes: a photoelectric conversion element for each pixel of the pixel array section; an electric charge transfer section disposed adjacent the photoelectric conversion element, for transferring a signal charge from the photoelectric conversion element in a predetermined direction and an electric charge transfer electrode for controlling the transfer of electric charges.

Still preferably, in a solid-state image capturing element according to the present invention, the high concentration well layer is disposed at least on an entire surface below the pixel array section.

An electronic information device according to the present invention includes the solid-state image capturing element according to the present invention as an image input device in an image capturing section thereof, thereby achieving the objective described above.

The functions of the present invention having the structures described above will be described hereinafter.

According to the present invention, a high concentration well layer is disposed in between a well of one conductivity type, and a semiconductor substrate or semiconductor region of the opposite conductivity type. The high concentration well layer has the same conductivity type as the well of one conductivity type and has a higher concentration of impurity than that of the well.

As a result, the ground potential is applied from a lower position to a well layer of each pixel by the high concentration well layer having a low resistance value, so that there will be no large difference in a voltage drop between the center portion and the peripheral portion of the pixel array section. Thus, it becomes possible to fix the ground potential of the well layer without a complication due to an increased number and controlling of parts as is required conventionally or without forming a well contact for each pixel, or without the generation of a fixed pattern noise, saturation level difference (saturation shading) or the decrease in focusing of light, as occurs conventionally.

For example, Reference 1 proposes to secure the photodiode capacity by reducing the area used for a contact diffusion region on the condition that a P well potential, for example, as a well of one conductivity type is fixed to a ground potential with a top contact. On the contrary, according to the present invention, for example, only a deep portion of the P well is highly concentrated, so that the P well potential is fixed to the ground potential without taking the top contact as done in Reference 1.

According to the present invention with the structure described above, a high concentration well layer is disposed in between a well of one conductivity type, and a semiconductor substrate or semiconductor region of the opposite conductivity type, the high concentration well layer having the same conductivity type as the well of one conductivity type and having a higher concentration of impurity than that of the well, so that there will be no large difference in a voltage drop between the center portion and the peripheral portion of the pixel array section by the high concentration well layer having a low resistance value. As a result, it becomes possible to fix the ground potential of the well layer without a complication due to an increased number and controlling of parts as is required conventionally or without forming a well contact for each pixel, or without the generation of a fixed pattern noise, saturation level difference (saturation shading) or the decrease in focusing of light, as occurs conventionally.

These and other advantages of the present invention will become apparent to those skilled in the art upon reading and understanding the following detailed description with reference to the accompanying figures.

### BRIEF DESCRIPTION OF THE DRAWINGS

FIG. 1 is a longitudinal cross sectional view illustrating one example of a cross sectional structure of a CMOS solid-state image capturing element for one pixel according to Embodiment 1 of the present invention.

FIG. 2 is a longitudinal cross sectional view illustrating one example of a cross sectional structure of a pixel array and an external terminal region in the outer circumference thereof of the CMOS solid-state image capturing element of FIG. 1.

FIG. 3 is a distribution chart of impurity concentration illustrating one example of an impurity profile in the depth direction of the photoelectric conversion region 4 of FIG. 1.

FIG. 4 is a block diagram schematically illustrating an exemplary configuration of an electronic information device of Embodiment 2 of the present invention, using a solid-state image capturing apparatus including the solid-state image capturing element 1 according to Embodiment 1 of the present invention in an image capturing section.

FIG. 5 is a plan-surface pattern diagram illustrating a pixel structure according to a conventional solid-state image capturing element disclosed in Reference 1.

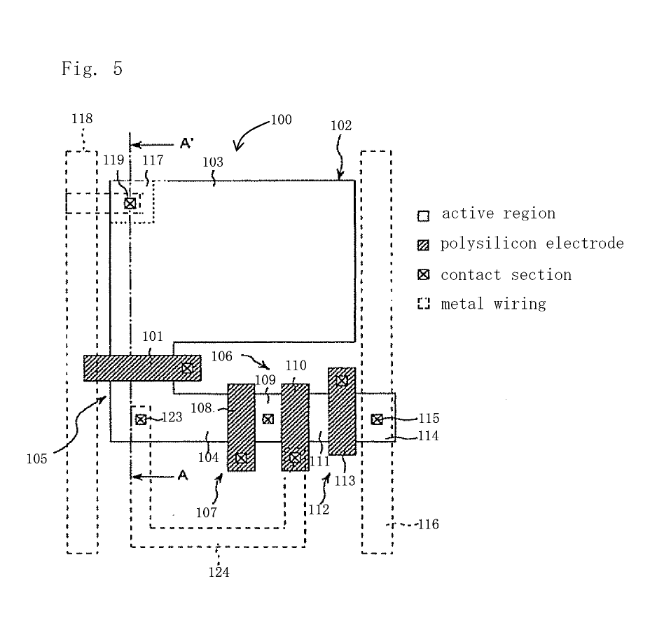

FIG. 6 is a cross sectional view along the line A-A′ of FIG. 5.

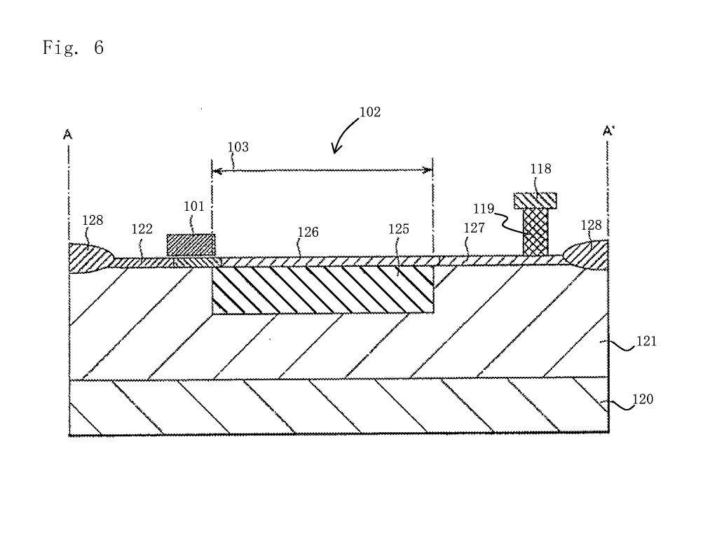

FIG. 7 is a plan-view pattern diagram illustrating a pixel structure according to a conventional solid-state image capturing element disclosed in Reference 2.

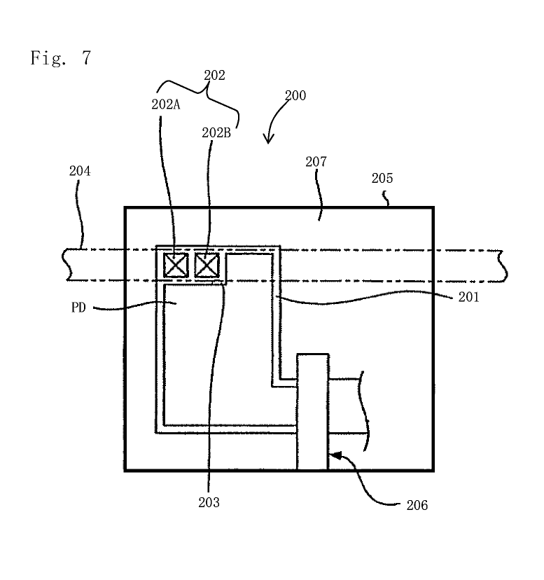

FIG. 8 is a potential diagram illustrating one example for describing the case where an electric potential of a transfer gate TG is set in a floating state, and the electric potential of the transfer gate TG is changed following the change in the electric potential of a P well so that the electric charge accumulating capacity of the photodiode PD will not be changed.

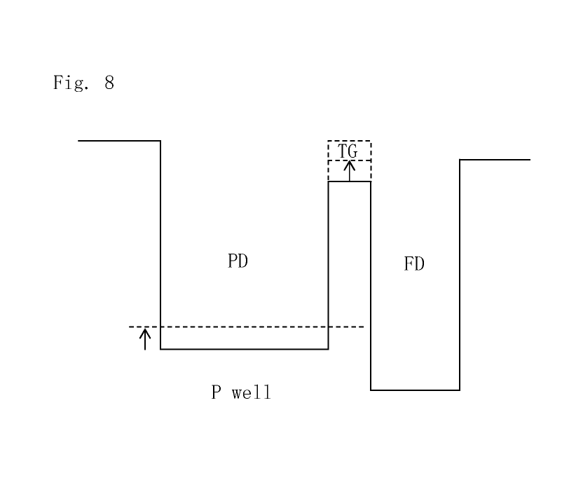

1 solid-state image capturing element

2 N substrate

3 P well

4 photoelectric conversion region (N−)

5 transfer transistor

5a transfer channel

5b transfer gate

6 surface P+ layer

7 P pixel separation layer

8 high concentration P well layer

FD charge-to-voltage converting section

STI insulation layer

90 electronic information device

91 solid-state image capturing apparatus

92 memory section

93 display section

94 communication section

95 image output section

### DESCRIPTION OF THE PREFERRED EMBODIMENTS

Herein after, a solid-state image capturing element according to the present invention as Embodiment 1; and an electronic information device as Embodiment 2, such as a camera-equipped cell phone device, including the solid-state image capturing element of Embodiment 1 as an image input device in an image capturing section thereof, will be described in detail with reference to the attached figures.

### Embodiment 1

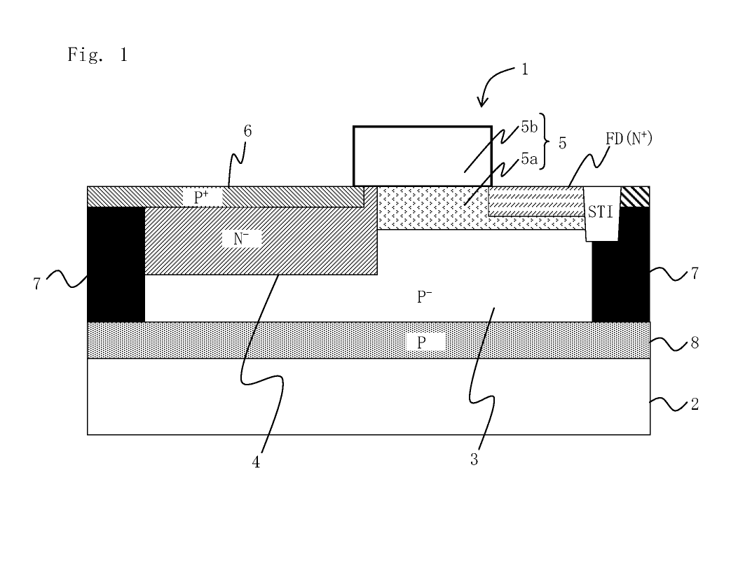

FIG. 1 is a longitudinal cross sectional view illustrating one example of a cross sectional structure of a CMOS solid-state image capturing element for one pixel according to Embodiment 1 of the present invention.

In FIG. 1, a solid-state image capturing element 1 of Embodiment 1 includes: a P well 3 disposed on an N substrate 2 (N-type semiconductor substrate or N-type semiconductor region); and a photoelectric conversion region (N−) 4 as a light receiving section for performing a photoelectric conversion on incident light to generate signal charges, disposed in the P well 3 functioning as a well layer. A transfer channel 5a is disposed between the photoelectric conversion region (N−) 4 and a floating diffusion (N+), which is a charge-to-voltage converting section FD as a voltage detecting section. A transfer gate 5b is disposed above the transfer channel 5a with a gate insulation film interposed therebetween. A transfer transistor 5 functioning as an electric charge transferring section is constituted of the transfer channel 5a and the transfer gate 5b.

The photoelectric conversion region (N−) 4 is buried by a surface P+ layer 6 on the surface portion and the transfer gate 5b, so that noise due to the surface crystal defect is controlled. Each pixel section is constituted of the P well 3, photoelectric conversion region (N−) 4, transfer channel 5a and charge-to-voltage converting section FD. An insulation layer STI and a P pixel separation layer 7, as an element separation layer, are disposed between the pixel section and an adjacent pixel section.

A high concentration P well layer 8 is disposed between the N substrate 2 and the P well 3. The high concentration P well layer 8 is the same conductivity type as the P well 3 and the impurity concentration is higher than that of the P well 3. The insulation layer STI, P pixel separation layer 7, and the high concentration P well layer 8 surround the P well 3 as well as the photoelectric conversion region 4, transfer channel 5a and charge-to-voltage converting section FD in the P well 3, for each pixel section. The high concentration P well layer 8 is disposed with a predetermined thickness at least on the entire surface below the pixel array section (image capturing region).

The N substrate 2 is used for the controlling of cross talk. By using the N substrate 2, signal charges from obliquely-entering incident light in a deep part of the substrate transfer, not to the adjacent pixel section, but to the N substrate 2. Therefore, the cross talk component from the adjacent pixel section can be better eliminated compared to a P substrate.

Herein, the N substrate 2 is used and the P well 3 is formed on the N substrate 2. It is desirable that the impurity concentration of a junction region (PN junction section) between the P well 3 and the photoelectric conversion region (N−) 4 be about 3×10¹⁵ cm⁻³. That is because the effect of a depletion layer of the photoelectric conversion region (N−) 4 extending to the side of the deep part of the substrate improves the quantum effect (QE) of long-wave length (red) light. Further, in a deep part of the P well 3, the high concentration P well layer 8 of a peak concentration of between 1×10¹⁷ cm⁻³ and 5×10¹⁷ cm⁻³ is formed. The sheet resistance of the high concentration P well layer 8 is approximately 1000 Ω/sq. (800-2000 Ω/sq.) here.

Further, for each photoelectric conversion region (N−) 4, signal charges are transferred to the floating diffusion (N+) as a charge-to-voltage converting section FD. The transferred signal charges are converted into voltage to be amplified in accordance with the converted voltage. The amplified signals are read out as image capturing signals for each pixel section. A plurality of transistors for performing these functions constitute the signal reading circuit, and the signal reading circuit is provided for each pixel section. In summary, each pixel in the pixel array section includes: a charge transfer section for transferring signal charges, on which photoelectric conversion is performed at a photoelectric conversion element constituted of the P well 3 and the photoelectric conversion region (N−) 4, to the voltage detecting section FD; and a signal reading circuit in which signal voltage detected from signal charges at the floating diffusion (N+) as a charge-to-voltage converting section FD is amplified to be output as image capturing signals.

The signal reading circuit includes: an amplification section (amplification transistor) for amplifying signal voltage detected at the floating diffusion (N+), which functions as a charge-to-voltage converting section FD, to be output as image capturing signals; a reset section (reset transistor) for resetting the signal voltage of the floating diffusion (N+) to a predetermined voltage (power supply voltage); and a selection section (selection transistor) for selecting a pixel of any address in the pixel array section.

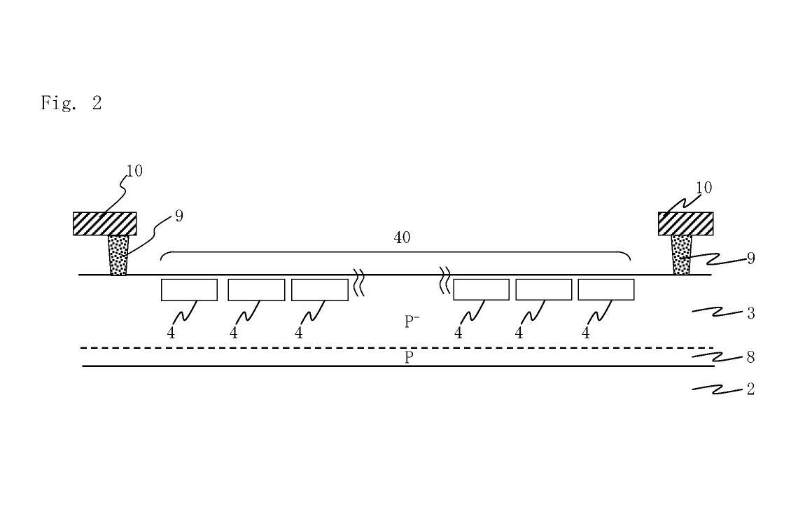

FIG. 2 is a longitudinal cross sectional view illustrating one example of a cross sectional structure of a pixel array and an external terminal region in the outer circumference thereof of the CMOS solid-state image capturing element of FIG. 1.

In FIG. 2, the pixel sections each including the photoelectric conversion region (N−) 4 are arranged in a two dimensional array in the center region (image capturing region) of the p well 3 to constitute a pixel array section 40. In the periphery of the center region in the P well 3 and the outside of the pixel array section 40, the P well 3 is electrically connected to a metal wiring 10 with a substrate top contact 9 interposed therebetween, to fix the P well 3 to a constant potential of the ground potential (0V) through the substrate top contact 9.

In summary, the metal wiring 10 is electrically connected in parallel to the plurality of substrate top contacts 9 at the outer circumference end portion of the substrate. Further, the plurality of substrate top contacts 9 are electrically connected to the high concentration P well layer 8. The P well 3 for each pixel section is fixed to the ground potential with the high concentration P well layer 8 interposed therebetween.

If the resistance of the high concentration P well layer 8 is large, the voltage difference becomes large between the ground potential of the pixel section in the center portion of the image capturing region constituting the pixel array section 40 and the ground potential of the pixel section in the peripheral portion. Therefore, the impurity concentration is set to be high so that the resistance of the high concentration P well layer 8 is even reduced. The high concentration P well layer 8 in the deep part of the substrate is connected to the P well 3 for each pixel section, with a P pixel separation layer (P−) interposed therebetween in parallel to the plurality of substrate top contacts 9 at an outer circumference end portion of the substrate. The impurity concentration is defined as follows: surface P+ layer 6 (concentration of about 1×10¹⁸ cm⁻³)>high concentration P well layer 8 (concentration of between 1×10¹⁷ cm⁻³ and 5×10¹⁷ cm⁻³)>P pixel separation layer 7 (concentration of about 5×10¹⁶ cm⁻³)>P well 3 (concentration of about 1×10¹⁶ cm⁻³). In order to reduce the resistance value for stably fixing the ground potential to the P well 3, it is necessary for the concentration of the high concentration P well layer 8 to be 1×10¹⁷ cm⁻³ or more. In addition, if the concentration of the high concentration P well layer 8 exceeds 5×10¹⁷ cm⁻³, the photoelectric conversion region is repressed and becomes narrow due to the spread of the diffusion layer to the photoelectric conversion region by heat treatment, which leads, in particular, to a lowering of the photoelectric conversion efficiency of red light in the deep part of the substrate.

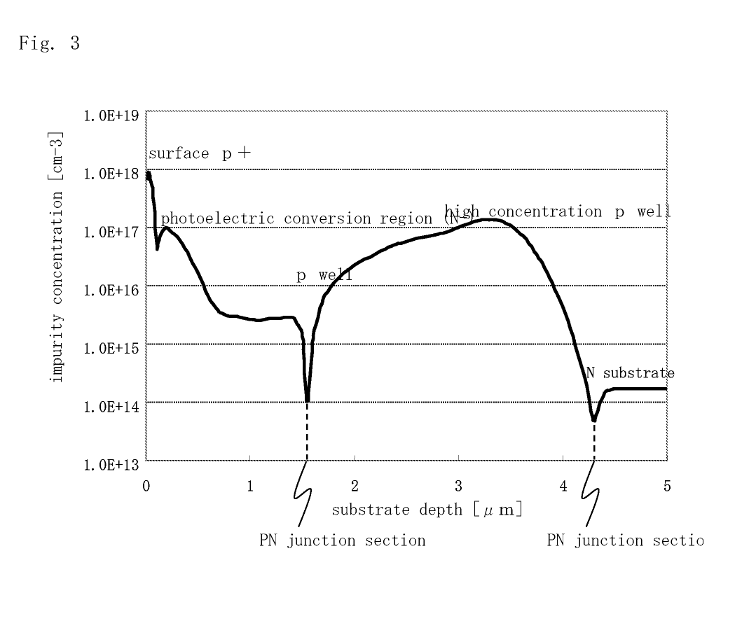

FIG. 3 is a distribution chart of impurity concentration illustrating one example of an impurity profile in the depth direction of the photoelectric conversion region 4 of FIG. 1.

As illustrated in FIG. 3, the high concentration P well layer 8 of the peak concentration of between 1×10¹⁷ cm⁻³ and 5×10¹⁷ cm⁻³ is formed below the P well 3 in order to secure a low resistance value of the high concentration well layer 8 for fixing the ground potential. The depth of the peak concentration of the high concentration P well layer 8 is 3.3 μm. Since the depth of the peak concentration of the high concentration P well layer 8 is 3.3 μm, the signal charges photoelectrically converted before reaching the depth of 3.3 μm are all captured and accumulated by the concentration gradient of FIG. 3. The depth of the high concentration P well layer 8 is 3 μm to 4 μm. If the depth of the high concentration P well layer 8 is too shallow, the area forming the photodiode PD is repressed, which influences the sensitivity and the number of saturation electrons. If the depth of the high concentration P well layer 8 is too deep, electrons due to obliquely-entering light do not go through to the side of the N substrate 2 and cross talk to adjacent pixel sections will be a problem (which is the same effect as using a P substrate).

Therefore, according to the conventional technique, a well contact is provided for each pixel section and the well is fixed to the ground. Alternatively, according to the technique of the present invention, the P well 3 is electrically fixed to a predetermined ground potential in the outer circumference portion of the pixel array section 40 without providing a well contact for each pixel, so that there will be no large difference between the voltage drop generated at the center region and at the peripheral region of the pixel array section 40, and a predetermined ground potential can be fixed in the center region and the peripheral region of the pixel array section 40. This is due to an effect of reducing diffusion resistance in the P well 3 and the high concentration P well layer 8 as a result of setting impurity resistance high in the high concentration P well layer 8 below the P well 3. Because of this effect, it becomes possible to obtain solid-state image capturing elements including the CMOS solid-state image capturing element 1 capable of fixing the P well 3 to the ground potential without a generation of fixed pattern noise, a saturation level difference (saturation shading) or a decrease in the focusing of light.

According to Embodiment 1 with the structure described above, the high concentration P well layer 8, which is the same conductivity type as the P well and has higher impurity concentration than the well of the same conductivity type, is disposed between the P well 3 and the N substrate 2, so that there will be no large difference in voltage drop between the center portion and the peripheral portion of the pixel array section 40. As a result, it becomes possible to fix the ground potential of the P well 3 in a more stable manner without a complication due to an increased number and controlling of parts as is required conventionally or without forming a well contact for each pixel, or without the generation of a fixed pattern noise, saturation level difference (saturation shading) or the decrease in focusing of light, as occurs conventionally.

Although the present invention is applied in the CMOS solid-state image capturing element (CMOS image sensor) in Embodiment 1, without the limitation to this, the present invention can also be applied to a CCD solid-state image capturing element (CCD image sensor).

In each pixel section of the CCD image sensor, a photodiode section for performing a photoelectric conversion on incident light to generate signal charges, as a light receiving section is disposed. Furthermore, an electric charge transfer section for transferring signal charges from the photodiode section is disposed adjacent to each photodiode section, and a gate electrode as an electric charge transferring electrode for controlling the transfer of the electric charges is disposed on the electric charge transfer section. On the gate electrode, a light shielding film is formed to prevent noise from being generated due to the reflection of incident light at the gate electrode. Furthermore, a microlens is disposed above the photodiode to focus light on the photodiode from an opening of the light shielding film through an inter-layer insulation film. The photodiode section and the electric charge transfer section are disposed in the P well, and a high concentration P well layer 8 similar to the one in Embodiment 1 may be disposed between the P well and the semiconductor substrate.

The impurity concentration is set high in the high concentration P well layer 8 below the P well, so that the diffusion resistance is reduced in the P well and the high concentration P well layer 8 themselves. As a result, it becomes possible to achieve the objective of the present invention to fix the ground potential of the P well without forming a well contact for each pixel, or without the generation of a fixed pattern noise, saturation level difference (saturation shading) or a decrease in focusing of light, as occurs conventionally.

### Embodiment 2

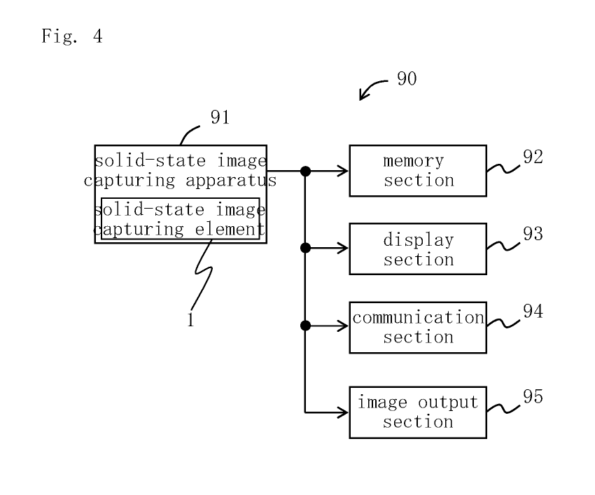

FIG. 4 is a block diagram schematically illustrating an exemplary configuration of an electronic information device of Embodiment 2 of the present invention, using a solid-state image capturing apparatus including the solid-state image capturing element 1 according to Embodiment 1 of the present invention in an image capturing section.

In FIG. 4, an electronic information device 90 according to Embodiment 2 of the present invention includes: a solid-state image capturing apparatus 91 for performing various signal processing on an image capturing signal from the solid-state image capturing element 1 according to Embodiment 1 so as to obtain a color image signal; a memory section 92 (e.g., recording media) for data-recording a color image signal from the solid-state image capturing apparatus 91 after a predetermined signal processing is performed on the color image signal for recording; a display section 93 (e.g., a liquid crystal display apparatus) for displaying the color image signal from the solid-state image capturing apparatus 91 on a display screen (e.g., liquid crystal display screen) after predetermined signal processing is performed on the color image signal for display; a communication section 94 (e.g., a transmitting and receiving device) for communicating the color image signal from the solid-state image capturing apparatus 91 after predetermined signal processing is performed on the color image signal for communication; and an image output section 95 (e.g., a printer) for printing the color image signal from the solid-state image capturing apparatus 91 after predetermined signal processing is performed for printing. The electronic information device 90 may include any of the memory section 92, the display section 93, the communication section 94, and the image output section 95, in addition to the solid-state image capturing apparatus 91.

As the electronic information device 90, an electronic device that includes an image input device is conceivable, such as a digital camera (e.g., digital video camera or digital still camera), an image input camera (e.g., a monitoring camera, a door phone camera, a camera equipped in a vehicle, or a television camera), a scanner, a facsimile machine, a camera-equipped cell phone device or a personal digital assistant (PDA).

Therefore, according to Embodiment 2 of the present invention, the color image signal from the solid-state image capturing apparatus 91 can be: displayed on a display screen properly by the display section 93, printed out on a sheet of paper using an image output section 95, communicated properly as communication data via a wire or a radio by the communication section 94, stored properly at the memory section 92 by performing predetermined data compression processing; and various data processes can be properly performed.

In Embodiment 1, as the solid-state image capturing element 1, the P well 3 is disposed above the N substrate 2, the photoelectric conversion region (N−) 4 is disposed in the P well 3, and the transfer channel 5a is disposed between the photoelectric conversion region (N−) 4 and the floating diffusion (N+) functioning as the charge-to-voltage converting section FD. In addition, the insulation layer STI and P pixel separation layer 7 are disposed as an element separation layer in between adjacent pixel sections. Furthermore, the high concentration P well layer 8, which is P type, the same conductivity type as the P well, and has higher impurity concentration than the P well 3, is disposed between the N substrate 2 and the P well 3. Without the limitation to this, the conductivity type may be completely opposite with a positive hole as a charge carrier instead of electrons. That is, an N well is disposed above a P substrate, a photoelectric conversion region (P−) is disposed in the N well, and a transfer channel is disposed between the photoelectric conversion region (P−) and a floating diffusion (P+) functioning as a charge-to-voltage converting section FD. Furthermore, an insulation layer STI and an N pixel separation layer are disposed as an element separation layer in between adjacent pixel sections. Furthermore, a high concentration N well layer (corresponding to the high concentration P well layer 8 of Embodiment 1), which is an N type, the same conductivity type as the N well, and has higher impurity concentration than the N well, is disposed between the P substrate and the N well. In this case, a surface N+ layer is disposed instead of the surface P+ layer 6 of Embodiment 1.

Although not specifically described in Embodiment 1, the high concentration P well layer 8, which is the same conductivity type as the P well 3 and has higher impurity concentration than the P well 3, is disposed between the P well 3 and the N substrate 2, so that there will be no large difference in voltage drop between the center portion and the peripheral portion of the pixel array section 40. As a result, it becomes possible to achieve the objective of the present invention to fix the ground potential of the well, without a complication of an increase and controlling of the number of parts as is required conventionally, without forming a well contact for each pixel, or without the generation of a fixed pattern noise, saturation level difference (saturation shading) or the decrease in focusing of light, as occurs conventionally.

As described above, the present invention is exemplified by the use of its preferred Embodiments 1 and 2. However, the present invention should not be interpreted solely based on Embodiments 1 and 2 described above. It is understood that the scope of the present invention should be interpreted solely based on the claims. It is also understood that those skilled in the art can implement equivalent scope of technology, based on the description of the present invention and common knowledge from the description of the detailed preferred Embodiments 1 and 2 of the present invention. Furthermore, it is understood that any patent, any patent application and any references cited in the present specification should be incorporated by reference in the present specification in the same manner as the contents are specifically described therein.

### INDUSTRIAL APPLICABILITY

The present invention can be applied in the field of a solid-state image capturing element, such as a CMOS solid-state image capturing element, constituted of a semiconductor element for performing a photoelectric conversion on and capturing an image of image light from a subject; and an electronic information device, such as a digital camera (e.g., a digital video camera or a digital still camera), an image input camera, a scanner, a facsimile machine, a television telephone device and a camera-equipped cell phone device, including the solid-state image capturing apparatus as an image input device used in an image capturing section thereof. According to the present invention, a high concentration well layer is disposed in between a well of one conductivity type and a semiconductor substrate or semiconductor region of the opposite conductivity type, the high concentration well layer having the same conductivity type as the well of one conductivity type and having a higher concentration of impurity than that of the well, so that there will be no large difference in a voltage drop between the center portion and the peripheral portion of the pixel array section due to the high concentration well layer having a low resistance value. As a result, it becomes possible to fix the ground potential of the well layer without a complication due to an increased number and controlling of parts as is required conventionally or without forming a well contact for each pixel, or without the generation of a fixed pattern noise, saturation level difference (saturation shading) or the decrease in focusing of light, as occurs conventionally.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. A solid-state image capturing element, comprising a pixel array section, in which a well layer is disposed above a semiconductor substrate or a semiconductor region and a plurality of photoelectric conversion elements for performing a photoelectric conversion on and capturing an image of image light from a subject are arranged in a two dimensional array in the well layer,
wherein a high concentration well layer is disposed between the well layer and the semiconductor substrate or the semiconductor region, the high concentration well layer being a same conductivity type as the well layer and having a higher impurity concentration than that of the well layer.

2. A solid-state image capturing element according to claim 1, wherein a peak concentration of the high concentration well layer is between 1×10¹⁷ cm⁻³ and 5×10¹⁷ cm⁻³.

3. A solid-state image capturing element according to claim 1, wherein a sheet resistance of the high concentration well layer is between 800 Ω/sq.-2000 Ω/sq.

4. A solid-state image capturing element according to claim 1, wherein a depth of the high concentration well layer is between 3 μm and 4 μm from a surface.

5. A solid-state image capturing element according to claim 1, wherein the well layer and the high concentration well layer are fixed at a constant electric potential from an outer circumference portion side of the pixel array section.

6. A solid-state image capturing element according to claim 1, wherein of the well layers, the well layer on the outer circumference portion side of the pixel array section is electrically connected to a metal wiring with a plurality of contacts interposed therebetween.

7. A solid-state image capturing element according to claim 1, wherein each photoelectric conversion element includes:
the well layer of a second conductivity type disposed above the semiconductor substrate of a first conductivity type or the semiconductor region of the first conductivity type; and
an impurity region of the first conductivity type disposed in the well layer of the second conductivity type.

8. A solid-state image capturing element according to claim 7, wherein the impurity region of the first conductivity type is buried by a surface impurity high concentration region of the second conductivity type thereabove.

9. A solid-state image capturing element according to claim 1, wherein each pixel of the pixel array section is separated from other pixels by the impurity region of the same conductivity type as that of the well layer.

10. A solid-state image capturing element according to claim 7, wherein each pixel of the pixel array section is separated from other pixels by the impurity region of the same conductivity type as that of the well layer.

11. A solid-state image capturing element according to claim 1, wherein the solid-state image capturing element is a CMOS-type solid-state image capturing element or a CCD-type solid-state image capturing element.

12. A solid-state image capturing element according to claim 11, wherein each pixel in the pixel array section includes: an electric charge transfer section for transferring a signal charge photoelectrically converted in the photoelectric conversion element to a voltage detecting section; and a signal reading circuit for amplifying a signal voltage detected from the signal charges at the voltage detecting section to be output as an image capturing signal.

13. A solid-state image capturing element according to claim 12, wherein the signal reading circuit includes:
an amplifying section for amplifying the signal voltage detected at the voltage detecting section to be output as the image capturing signal; and
a reset section for resetting the signal voltage of the voltage detecting section to a predetermined voltage after outputting the image capturing signal.

14. A solid-state image capturing element according to claim 13, wherein the signal reading circuit further includes a selection section for selecting a pixel of any address in the pixel array section for each pixel of the pixel array section.

15. A solid-state image capturing element according to claim 11, further including:
a photoelectric conversion element for each pixel of the pixel array section;
an electric charge transfer section disposed adjacent the photoelectric conversion element, for transferring a signal charge from the photoelectric conversion element in a predetermined direction and
an electric charge transfer electrode for controlling the transfer of electric charges.

16. A solid-state image capturing element according to claim 1, wherein the high concentration well layer is disposed at least on an entire surface below the pixel array section.

17. An electronic information device including the solid-state image capturing element according to claim 1 as an image input device in an image capturing section thereof.
